(19) United States
(12) Patent Application Publication
(10) Pub. No.: US 2017/0234271 A1
(43) Pub. Date: Aug. 17, 2017

(54) EXHAUST GAS RECIRCULATION SYSTEM

(71) Applicant: Electro-Motive Diesel, Inc., LaGrange, IL (US)

(72) Inventors: Keith E. Moravec, Downers Grove, IL (US); Sudarshan K. Loya, Naperville, IL (US); Michael B. Goetzke, Orland Park, IL (US); Reddy P. Sankara, Lisle, IL (US)

(73) Assignee: Electro-Motive Diesel, Inc., LaGrange, IL (US)

(21) Appl. No.: 15/044,537

(22) Filed: Feb. 16, 2016

(51) Int. Cl. F02M 26/24; F02M 26/33; F02M 26/47; F02M 26/25

(52) U.S. Cl. CPC F02M 26/24; F02M 26/25; F02M 26/33; F02M 26/47

(57) ABSTRACT

The exhaust gas recirculation system includes a plurality of coolers arranged in a predefined configuration that are configured to receive a flow of exhaust gas and a flow of coolant therethrough. The exhaust gas recirculation system further includes plurality of valves associated with each of the plurality of coolers. The plurality of valves is configured to regulate at least one of the flows of exhaust gas and the coolant through the corresponding cooler. The exhaust gas recirculation system also includes a control unit configured to selectively switch opening and closing of the plurality of valves such that at least one of the flow of exhaust gas and the flow of coolant through at least one cooler of the plurality of coolers is regulated during an operation of the exhaust gas recirculation system, to actively regenerate the at least one cooler.

### TECHNICAL FIELD

The present disclosure relates to an engine exhaust system, and more particularly relates to an exhaust gas recirculation system to effectively carry out regeneration of a plurality of coolers.

### BACKGROUND

Typically, exhaust gas recirculation (EGR) system are employed in engines for reducing various engine emissions. The EGR system returns the exhaust gas back to the engine after the exhaust gas is cooled. The exhaust gas is cooled by means of exhaust gas recirculation coolers. The Exhaust Gas Recirculation Coolers are subjected to deposition of exhaust particles, known as “fouling”. The deposition of exhaust particles such as hydrocarbon, soot etc. that reduces the efficiency of cooling the exhaust gas as the exhaust particles is non-conductive. The loss in amount of heat transfer may result in increase in temperature within the EGR system. Further, the lower heat transfer rate may increase the pressure drop across the flow of exhaust gas within the EGR system. The drop in pressure within the EGR system may increase the back pressure on the engine which may increase the fuel consumption of the engine.

US Publication Number 2013/0042841 discloses an exhaust gas recirculation system for an internal combustion engine. The exhaust gas recirculation system includes an exhaust gas recirculation system for an internal combustion engine that includes an exhaust gas recirculation conduit. The exhaust gas recirculation conduit fluidly connects an exhaust manifold to an intake manifold of the internal combustion engine, first and second exhaust gas coolers that are located in series in the exhaust gas recirculation conduit. Each of the first and second exhaust gas coolers includes an inlet and an outlet fluidly connected to a first and a second coolant circuit respectively. Further, the second coolant circuit includes a radiator having a coolant inlet in fluid communication with the coolant outlet of the second exhaust gas cooler, a pump having a coolant inlet in fluid communication with a coolant outlet of the radiator and a coolant outlet in fluid communication with the coolant inlet of the second exhaust gas cooler, and an additional conduit fluidly connecting the coolant outlet of the exhaust cooler. However, the said disclosure does not provide any means for de-fouling of the exhaust gas recirculation coolers in the exhaust gas recirculation system.

### SUMMARY OF THE DISCLOSURE

In one aspect of the present disclosure, an exhaust gas recirculation system is provided. The exhaust gas recirculation system includes a plurality of coolers arranged in a predefined configuration that are configured to receive a flow of exhaust gas and a flow of coolant therethrough. The exhaust gas recirculation system further includes plurality of valves associated with each of the plurality of coolers. The plurality of valves is configured to regulate at least one of the flows of exhaust gas and the coolant through the corresponding cooler. The exhaust gas recirculation system also includes a control unit configured to selectively switch opening and closing of the plurality of valves such that at least one of the flow of exhaust gas and the flow of coolant through at least one cooler of the plurality of coolers is regulated during an operation of the exhaust gas recirculation system, to actively regenerate the at least one cooler.

In another aspect of the present disclosure, an internal combustion engine includes is provided. The internal combustion engine includes one or more combustion cylinders. The internal combustion engine includes an intake manifold configured to supply a charge mixture to the one or more combustion cylinders, wherein the one or more combustion cylinders are configured to burn the charge mixture to generate power and produce exhaust gases. The internal combustion engine further includes an exhaust manifold configured to receive the exhaust gas from the one or more combustion cylinders. The internal combustion engine also includes an exhaust gas recirculation system fluidly connecting the exhaust manifold and the intake manifold. The exhaust gas recirculation system is configured to receive the exhaust gas from the exhaust manifold, extract heat from the exhaust gas and supply the exhaust gas to the intake manifold to generate the charge mixture. The exhaust gas recirculation system includes a plurality of coolers arranged in a predefined configuration. The plurality of coolers is configured to receive a flow of exhaust gas and a flow of coolant therethrough. The exhaust gas recirculation system further includes a plurality of valves associated with each of the plurality of coolers. The plurality of valves configured to regulate at least one of the flows of exhaust gas and the coolant through the corresponding cooler. The exhaust gas recirculation system includes a control unit. The control unit is configured to selectively switch opening and closing of the plurality of valves such that at least one of the flow of exhaust gas and the flow of coolant through at least one cooler of the plurality of coolers is regulated during an operation of the exhaust gas recirculation system, to actively regenerate at least one cooler.

In yet another aspect of the present disclosure, a method of actively regenerating coolers in an exhaust recirculation system is provided. The method includes arranging a plurality of coolers in a predefined configuration. The plurality of coolers configured to receive a flow of exhaust gas and a flow of coolant therethrough. The method further includes regulating at least one of the flows of exhaust gas and the coolant through each of the plurality of coolers via a plurality of valves. The method also includes selectively switching opening and closing of the plurality of valves such that at least one of the flow of exhaust gas and the flow of coolant through at least one cooler of the plurality of coolers is regulated during an operation of the exhaust gas recirculation system, to actively regenerate at least one cooler.

Other features and aspects of this disclosure will be apparent from the following description and the accompanying drawings.

### BRIEF DESCRIPTION OF THE DRAWINGS

FIG. 1 illustrates a schematic view of an exhaust recirculation system having an exhaust gas coolers arranged in a parallel configuration, according to an embodiment of the present disclosure;

FIG. 2 illustrates a schematic view of the exhaust recirculation system having an exhaust gas coolers arranged in series configuration, according to an embodiment of the present disclosure;

FIG. 3 illustrates a schematic view of the exhaust recirculation system having an exhaust gas coolers arranged in a hybrid configuration, according to an embodiment of the present disclosure; and

FIG. 4 illustrates a flowchart of a method to carry out regeneration of a plurality of coolers, according to an embodiment of the present disclosure.

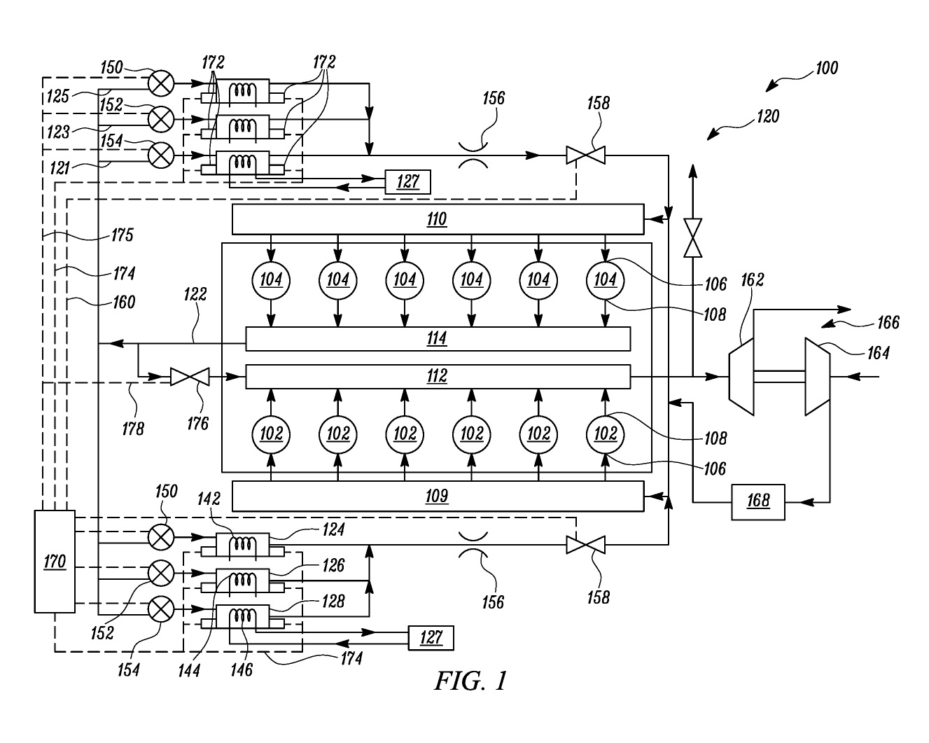

### DETAILED DESCRIPTION

Wherever possible, the same reference numbers will be used throughout the drawings to refer to the same or the like parts. Referring to the drawings, FIGS. 1-3 show schematic illustration of an exemplary engine 100 having an exhaust gas recirculation system 120. The engine 100 may be an internal combustion engine which runs on diesel, gasoline, gaseous fuels, or a combination thereof. The engine 100 may provide power to various types of applications and/or to machines, such as excavating machines, locomotives, passenger vehicles, electric generators, mining trucks, marine vessels, agricultural machines, and the like.

The engine 100 includes one or more sets of combustion cylinders 102, 104 implemented therein. The present embodiment shows a first set of combustion cylinders 102 alongside a second set of combustion cylinders 104. In the present embodiment, each set of the combustion cylinders 102, 104 disposes six cylinders. Although twelve combustion cylinders are shown, it may be contemplated that the actual number of cylinders of the engine 100 may vary and that the engine 100 may be of an in-line type, a V-type, a rotary type, or other types known in the art. Each of the sets of combustion cylinders 102, 104 may be configured to slidably receive a piston (not shown) therein. The engine 100 may also include one or more fuel injectors or admission valves or a combination thereof for providing fuel to the set of combustion cylinders 102, 104.

Each of the sets of combustion cylinders 102, 104 include an intake port 106 and an exhaust port 108. The engine 100 may include a first intake manifold 109 and a second intake manifold 110 in fluid communication with the first set of combustion cylinders 102 and the second set of combustion cylinders 104, respectively. The first intake manifold 109 is configured to supply charge mixture to the first set of combustion cylinders 102 and second intake manifold 110 is configured to supply a charge mixture to the second set of combustion cylinders 104. Further, the first and second sets of combustion cylinders 102, 104 are configured to burn the charge mixture to generate power and produce exhaust gases.

The engine 100 includes a first exhaust manifold 112 and a second exhaust manifold 114 in fluid communication with the first set of combustion cylinders 102 and the second set of combustion cylinders 104, respectively. The first exhaust manifold 112 and the second exhaust manifold 114 are configured to receive the exhaust gas from the first set of combustion cylinders 102 and the second set of combustion cylinders 104, respectively. It may be understood that the disclosed configuration of the engine 100 is exemplary only, and may vary as per the requirement and applications.

The exhaust gas recirculation system 120, within the engine 100, is in fluid communication with the first and second exhaust manifolds 112, 114. The exhaust gas recirculation system 120 fluidly connects the first and second exhaust manifolds 112, 114 with the first and second intake manifolds 109, 110. The exhaust gas recirculation system 120 includes an exhaust gas recirculation line 122, hereinafter referred as EGR line 122. The EGR line 122 is configured to allow a flow of the exhaust gas from the second exhaust manifold 114, throughout the exhaust gas recirculation system 120.

A plurality of coolers 124, 126 and 128 are disposed on the EGR line 122, as shown in FIG. 1. The plurality of coolers, herein after referred as EGR coolers 124, 126, and 128 are arranged in a predefined configuration. The EGR coolers 124, 126, 128, are configured to selectively receive the flow of exhaust gases. The EGR coolers 124, 126, 128 include coolant pipes 142, 144, 146 configured to selectively receive coolant therethrough. In the present embodiment, the exhaust gas recirculation system 120 includes a coolant supply unit 127. The coolant supply unit 127 is configured to supply coolant to the coolant pipes 142, 144, 146. The coolant supply unit 127 may use coolant such as water or a chemical known in the art. The coolant supply unit 127 may include a coolant reservoir, pumps and valves (not shown).

The exhaust gas recirculation system 120 includes a plurality of valves 150, 152, 154 as shown. The plurality of valves 150, 152, 154 are associated with each of the EGR coolers 124, 126, 128. The plurality of valves 150, 152, 154 is configured to regulate at least one of the flows of exhaust gas and the coolant (not shown) through the corresponding EGR coolers 124, 126, 128. The EGR line 122 includes a venturi 156 that is configured to measure the flow of the exhaust gas through the exhaust gas recirculation system 120.

The EGR line 122 also includes an EGR control valve 158. The EGR control valve 158 is positioned after the venturi 156. The EGR control valve 158 may be configured to control the flow of the exhaust gas. The EGR control valve 158 may be a variable control valve that may be controlled either manually or by electronic means. The EGR line 122 further directs the exhaust gas back to the first and second intake manifolds 109, 110. In one example, the exhaust gas that exits from the second exhaust manifold 114 is partly directed to the first exhaust manifold 112. The EGR line 122 disposes an exhaust valve 176. The exhaust valve 176 is configured to selectively restrict the flow of the exhaust gas.

In the present embodiment, the energy from the exhaust gas is extracted by an energy extraction device such as a turbine 162. The turbine 162 is coupled to a compressor 164 to form a turbocharger 166. The exhaust gas rotates the turbine 162, before being vented out to the atmosphere, which in turn rotates the compressor 164. The compressor 164 compresses the air from the atmosphere. The compressed air from the atmosphere is passed through an after-cooler 168. The after-cooler 168 cools the compressed air that is then supplied to the intake manifolds 109, 110.

The engine 100 includes a control unit 170 configured to control and monitor various operations and functions of the engine 100. The control unit 170 is capable of monitoring various functions of the engine 100 by use of sensors which are associated with the engine 100. The sensors are connected to the control unit 170 via multiple electric wires 174. The present embodiment includes one or more temperature sensors 172. The temperature sensors 172 may be positioned across an inlet and outlet of the EGR coolers 124, 126, and 128 respectively as shown. In an alternate embodiment, there may be temperature sensors positioned appropriately at the intake and exhaust manifolds to measure the temperature of the inlet and exhaust gas. The temperature sensors 172 are configured to determine the temperature of the exhaust gas that flows from the engine 100. Further, the temperature sensors 172 generate a temperature change signal based on the sensed change in the temperature as the exhaust gas flows through the EGR coolers 124, 126, and 128 respectively. Alternatively, the temperature can be determined by inference from other sensed data. The engine 100 may also include sensors such as engine speed sensor, and an intake manifold pressure sensor, all of which are not shown.

The control unit 170 is configured to switch the opening and closing of the valves 150, 152, and 154 that control the flow of exhaust gas through the EGR coolers 124, 126, 128. The control unit 170 is also configured to control the flow of coolant through the coolant pipes 142, 144, and 146. The valves 150, 152, 154 are connected to the control unit 170 by one or more electrical wires 175.

The control unit 170 controls the operation of the exhaust valve 176 and EGR control valve 158. The exhaust valve 176 is connected to the control unit 170 by an electrical wire 178. The EGR control valve 158 is connected to the control unit 170 by an electrical wire 160. The control unit 170 receives signal such as the change in temperature of the exhaust gas by the temperature sensors 172 and selectively controls the opening and closing of the valves 150, 152, 154 and the exhaust valve 176.

The control unit 170, also known as a control module or a controller, may take many forms including a computer based system, a microprocessor based system including a microprocessor, a microcontroller, or any other control type circuit or system. The control unit 170 may include memory for storage of a control program for operating and controlling the engine 100 of the present invention and other memory for temporary storage of information.

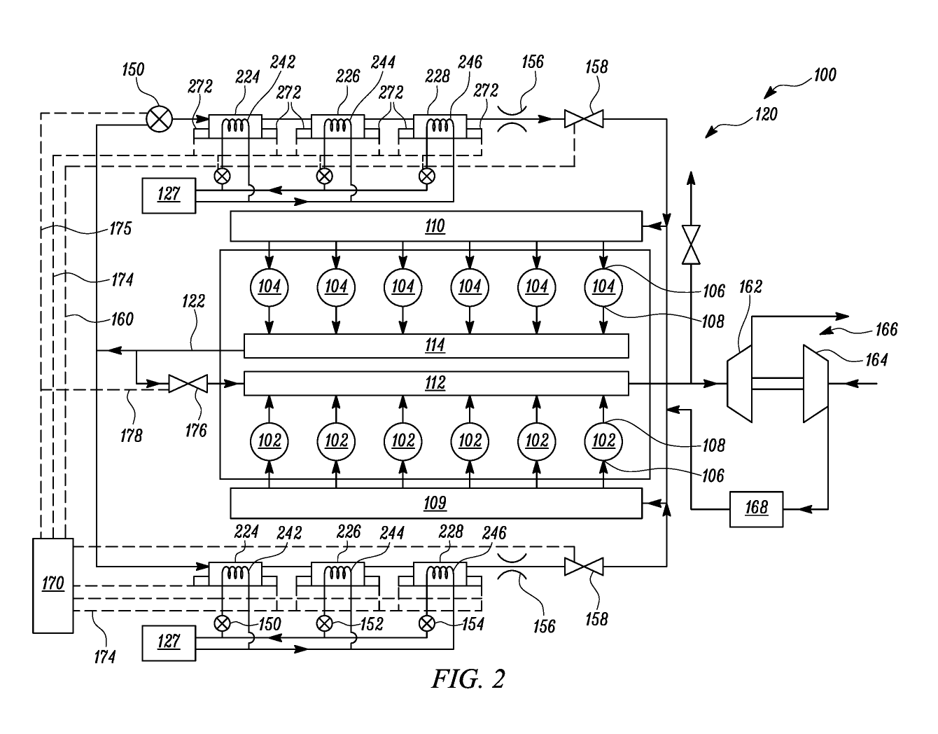

The present embodiment includes EGR coolers 124, 126, 128 that are arranged in various configurations such as parallel configuration or series configuration with respect to each other as shown in FIGS. 1 and 2, respectively. FIG. 1 shows a parallel configuration of the exhaust gas recirculation system 120. The parallel configuration of the exhaust gas recirculation system 120, as shown in FIG. 1, has an identical setup towards the first and second intake manifolds 109, 110. The EGR line 122 is split into more than one lines, say three EGR lines 121, 123, 125, parallel to each other as shown.

The exhaust recirculation system 120 disposes one EGR coolers 124, 126, 128 on each of the parallel EGR lines 121, 123, and 125 as shown. The EGR coolers 124, 126, 128 include coolant pipes 142, 144, 146 for exchanging heat from the exhaust gas. The EGR lines 121, 123, and 125 also dispose valves 150, 152 and 154. In the present disclosure the valves 150, 152, 154 are disposed before the EGR coolers 124, 126, 128 respectively, in the direction of flow of the exhaust gases. In an alternate embodiment the valves 150, 152, 154 may be disposed after the EGR coolers 124, 126, 128 respectively. The EGR line 121, 123, 125 includes temperature sensors 172 across each ends of the EGR coolers 124, 126, 128. It may be contemplated by a person skilled in the art that the parallel configuration may be implemented in various manners, such as, with the same arrangement of the EGR coolers 124, 126, 128 and associated components on two sides of the engine 100, as illustrated in FIG. 1, or any other possible manner.

Referring to FIG. 2, a series configuration of the exhaust gas recirculation system 120 is illustrated, in which the EGR line 122 disposes more than one, say three EGR coolers 224, 226, 228 in series as shown. The EGR line 122 disposes the EGR coolers 224, 226, 228 such that the exhaust gas exiting from one EGR cooler enters the next EGR cooler. Each of the EGR coolers 224, 226 and 228 include coolant pipes 242, 244 and 246 respectively as shown, for exchanging heat from the exhaust gas. The coolant pipes 242, 244, 246 dispose valves 150, 152, 154 that are configured to control the flow coolant. Further, the EGR line 122 also includes temperature sensors 272 across each ends of the EGR coolers 224, 226, 228. The temperature sensors 272 are connected by means of electrical wires 174, to the control unit 170.

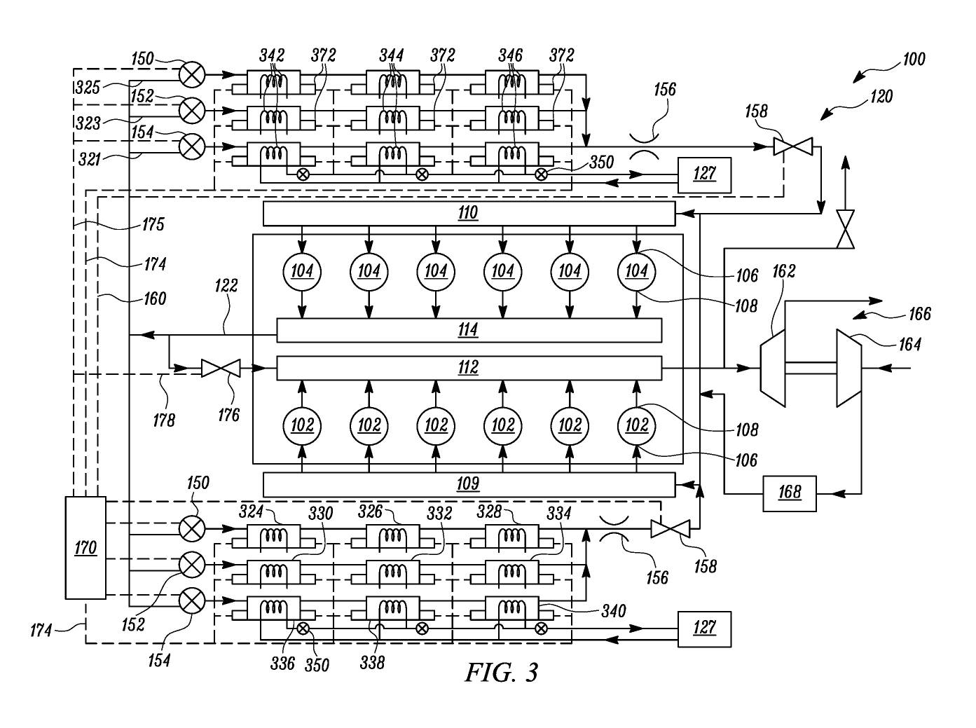

Referring to FIG. 3, a hybrid configuration of the exhaust gas recirculation system 120 is illustrated. The EGR line 122 is split into more than one lines say three EGR lines 321, 323, 325 parallel to each other as shown. Each EGR line 321, 323, 325 further, disposes more than one, say three sets of EGR coolers 324, 326, 328, also 330, 332, 334 and 336, 338, 340 respectively in series as shown. The EGR coolers 324, 326, 328 dispose coolant pipes 342, 344 and 346 for exchanging heat from the exhaust gas. Further, the flow of coolant (generally water) in the coolant pipes 342, 344, 346 is controlled by valves 350. The hybrid configuration also includes temperature sensors 372 disposed across each of EGR coolers 324, 326, 328, 330, 332, 334 336, 338, 340.

### Industrial Applicability

The exhaust gas recirculation system 120 is used to reduce the NOx from the exhaust gases and further improve the fuel efficiency of the engine 100. The exhaust gas that exits from the first and second exhaust manifolds 112, 114 may carry unburned fuel. The exhaust gas that may carry hydrocarbon and unburned fuel is fed back to the first and second sets of combustion cylinders 102, 104 by the exhaust gas recirculation system 120 thereby improving the fuel efficiency of the engine 100. The temperature of the exhaust gas is lowered by the EGR coolers 124, 126, 128. However, after certain duration of working the EGR coolers may develop layers formed of soot and ash particles carried by the exhaust gas. This phenomenon is called as “fouling”. The fouling of the EGR coolers may result in ineffective cooling of the exhaust gas.

During the operation of the engine 100, the first and second sets of combustion cylinders 102, 104 produce exhaust gas at high temperature. The exhaust gas passes into the first and the second exhaust manifolds 112, 114. The exhaust gas at high temperature is directed from the first exhaust manifolds 112 to the turbine 162 to run the turbocharger 166. The exhaust gas from the second exhaust manifold 114 is directed to the exhaust gas recirculation system 120. In an embodiment, a part of the exhaust gas from the second exhaust manifold 114 is sent to the turbocharger 166 via the control valve 176. The remaining exhaust gas is passed through the EGR line 122 that lower the temperature of the exhaust gas. The exhaust gas at lower temperature is then directed into the first and second intake manifolds 109,110 for combustion. The exhaust gas may carry particulate matter such as ash or soot that may get accumulated in layers over the coolant pipes. The accumulation of layers of formed of soot and ash over the coolant pipes may reduce the cooling efficiency of the EGR coolers, and increase back pressure on the engine leading to lower efficiency. The present disclosure is based on the method of removing the accumulated exhaust particles over the coolant pipes of the EGR coolers in parallel, series or hybrid configuration, the details of which will be discussed further.

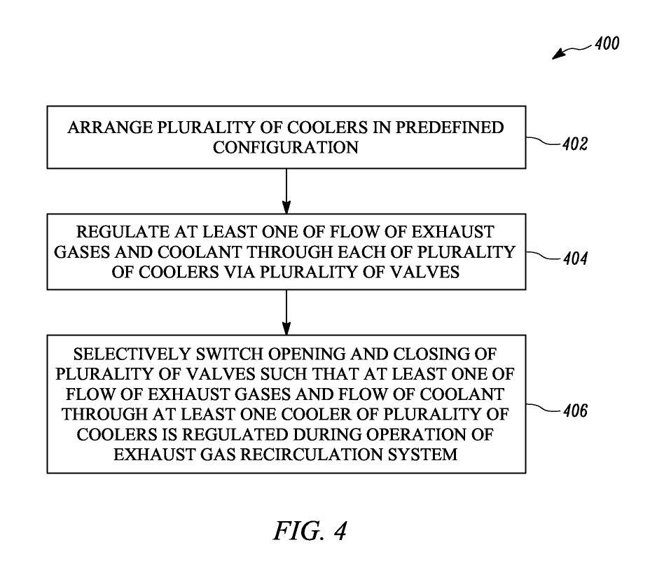

FIG. 4 shows a flowchart of a method 400 to regenerate the EGR coolers 124, 126, 128. At step 402, the EGR coolers 124, 126, 128 may be arranged in parallel, series and hybrid configuration as shown in FIGS. 1, 2 and 3 respectively, where the coolers 124, 126, 128 are configured to receive a flow of exhaust gas and a flow of coolant therethrough. The parallel configuration of the EGR line 122 aids in distribution of the flow of the exhaust gas into various coolers based on flow conditions and cooling requirements. During low or mid flow of the exhaust gas and low cooling requirements, a single EGR cooler may be selectively activated. During medium flow of the exhaust gas or mid cooling requirements, two or more EGR coolers may be activated. During high flow of the exhaust gas or high cooling requirements all EGR coolers may be selectively activated.

At step 404, the method 400 regulates either the flow of exhaust gas or the coolant through one or more of the plurality of EGR coolers 124, 126, 128. For example, the control unit 170 takes input such as the temperature of the exhaust gas entering and exiting the EGR cooler 124, engine load condition and the like. The control unit 170 processes the input based on the programed logic to control the opening or closing of the valves 150, 152, 154 (shown in FIGS. 1 and 2), and 350 (shown in FIG. 3), to control the flow of exhaust gas and coolant within the EGR coolers 124, 126, 128 (shown in FIG. 1), 224, 226, 228 (shown in FIG. 2) and 324, 330, 336 (shown in FIG. 3). If the control unit 170 detects that the exhaust gas may not require significant amount of cooling, that is, the engine 100 is operating at low load condition, one or more EGR coolers, say EGR cooler 124, may be deactivated by closing the valve 150. The control unit 170 signals the closure of the valve 150. The coolant will continue to flow through the coolant pipes 142. The temperature within the EGR cooler 124 will fall that will allow the layers formed of soot and ash to absorb the water particles within the EGR cooler 124. The layers formed of soot and ash will get moistened. Further, the layers formed of soot and ash may be removed by forced vibration due to the exhaust gas flow.

At step 406, the method 400, selectively switches either the opening and closing of the valves 150, 152, 154 such that the flow of exhaust gas or valves 150, 152, 154, 350 to control the flow of coolant through at least one cooler of the plurality of EGR coolers 124, 126, 128 is regulated during an operation of the exhaust gas recirculation system 120, to actively regenerate the at least one cooler. The control unit 170 then signals the opening of the valve 150 which allows the exhaust gas to pass through the coolant pipes 142. The difference in temperature and the pressure of the exhaust gas will remove the layers formed of soot and ash from the coolant pipes 142 thereby regenerating the EGR cooler 124. Similarly the other EGR coolers 126, 128 will be regenerated by the control unit 170. For example, the control unit 170 selectively stops the supply of exhaust gas through another EGR cooler say 126, and then after certain duration signals the valve 152 to re-supply the exhaust gas from the EGR cooler 126 to regenerate. In addition to regeneration, this also ensures that the flow is always higher in the EGR coolers even at low speed and load conditions as only a section the EGR cooler is activated for cooling the exhaust gas.

In another embodiment, at step 402 where the EGR coolers 124, 126, 128 are arranged in series as shown in FIG. 2. It may be contemplated that the fouling of the EGR coolers is significant over the cooler sections. The control unit 170 may sense fouling in say EGR cooler 226 due to layers formed of soot and ash. In an example, the fouling on the EGR cooler 228 can be regenerated by shutting off the supply of coolant in coolant pipes 242 and 244. In another example, the fouling can be prevented by avoiding condensation of exhaust gas on EGR cooler 228 by shutting the supply of coolant in coolant pipes 246. At step 404, the control unit 170 signals the closure of the valve 152 configured to control the flow of the coolant within the coolant pipes 244. The temperature of the layer formed of soot and ash over coolant pipes 244 and the parts of the EGR coolers 224, 226, 228 gets subjected to the exhaust gas, rises to a considerable amount. The control unit 170 may then signal the opening of the valve that controls the coolant flow through the coolant pipes 244. The flow of coolant within the coolant pipes 244 will lower the temperature of the layer in contact with the coolant pipes 244. The difference in the temperature of the layers formed of soot and ash may lead to regeneration of the EGR cooler 226. It may be contemplated that during scheduled maintenance of the EGR coolers 224, 226, 228 arranged in series configuration, the regeneration is carried out from the EGR cooler from which the exhaust gas is passed the latest.

In another embodiment, where the EGR coolers are arranged in hybrid configuration, the control unit 170 may signal to selectively regenerate the EGR coolers 324, 326, 328, 330, 332, 334, 336, 338, 340. The control unit 170 may signal the opening or closing of the valves 350 that control the flow of coolant or exhaust gas through each parallel EGR coolers 342, 344, 346 as the temperature sensors 372 signals the control unit 170 for the need of regeneration or to prevent condensation.

The parallel configuration of the EGR coolers 124, 126, 128 helps in selective regeneration of EGR coolers without affecting the working of the engine 100. The regeneration of EGR coolers 224, 226, 228 in series configuration has control valves 150, 152, 154 for controlling the flow of coolant through the coolant pipes 242, 244, 246. The hybrid configuration helps to combine the preventive and active regeneration techniques from the parallel and series flow described above.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust gas recirculation system, comprising:
a plurality of coolers arranged in a predefined configuration, each of the plurality of coolers configured to receive a flow of exhaust gas and a flow of coolant therethrough;
a plurality of valves associated with each of the plurality of coolers, each of the plurality of valves configured to regulate at least one of the flow of exhaust gas and the coolant through the corresponding cooler; and
a control unit configured to selectively switch opening and closing of the plurality of valves such that at least one of the flow of exhaust gas and the flow of coolant through at least one cooler of the plurality of coolers is regulated during an operation of the exhaust gas recirculation system, to actively regenerate the at least one cooler.

2. The exhaust gas recirculation system of claim 1, wherein the coolers are arranged in parallel configuration with respect to each other.

3. The exhaust gas recirculation system of claim 1, wherein the coolers are arranged in series configuration with respect to each other.

4. The exhaust gas recirculation system of claim 1, wherein the coolers are arranged in hybrid configuration with respect to each other.

5. The exhaust gas recirculation system of claim 1 further comprising, temperature sensors associated with each of the plurality of coolers, the temperature sensors configured to sense a change in temperature of at least one of the exhaust gas and the coolant as the exhaust gas and the coolant flow through the coolers, and generate a temperature change signal based on the sensed change in temperature, wherein the control unit is configured to selectively switch opening and closing of the plurality of valves based on the temperature change signal.

6. The exhaust gas recirculation system of claim 1, wherein the control unit is configured to selectively switch opening and closing of the plurality of valves based on a time signal.

7. The exhaust gas recirculation system of claim 1, wherein the control unit is further configured to selectively switch opening and closing of the plurality of valves based on a flow rate of the exhaust gas.

8. An internal combustion engine comprising:
one or more combustion cylinders;
an intake manifold configured to supply a charge mixture to the one or more combustion cylinders, wherein the one or more combustion cylinders are configured to burn the charge mixture to generate power and produce exhaust gases;
an exhaust manifold configured to receive the exhaust gas from the one or more combustion cylinders; and
an exhaust gas recirculation system fluidly connecting the exhaust manifold and the intake manifold, the exhaust gas recirculation system configured to receive the exhaust gas from the exhaust manifold, extract heat from the exhaust gas and supply the exhaust gas to the intake manifold to generate the charge mixture, the exhaust gas recirculation system comprising:
a plurality of coolers arranged in a predefined configuration, each of the plurality of coolers configured to receive a flow of exhaust gas and a flow of coolant therethrough;
a plurality of valves associated with each of the plurality of coolers, each of the plurality of valves configured to regulate at least one of the flow of exhaust gas and the coolant through the corresponding cooler; and
a control unit configured to selectively switch opening and closing of the plurality of valves such that at least one of the flow of exhaust gas and the flow of coolant through at least one cooler of the plurality of coolers is regulated during an operation of the exhaust gas recirculation system, to actively regenerate the at least one cooler.

9. The internal combustion engine of claim 8, wherein the coolers are arranged in parallel configuration with respect to each other.

10. The internal combustion engine of claim 8, wherein the coolers are arranged in series configuration with respect to each other.

11. The internal combustion engine of claim 8, wherein the coolers are arranged in hybrid configuration with respect to each other.

12. The internal combustion engine of claim 8 further comprising, temperature sensors associated with each of the plurality of coolers, the temperature sensors configured to sense a change in temperature of at least one of the exhaust gas and the coolant as the exhaust gas and the coolant flow through the coolers, and generate a temperature change signal based on the sensed change in temperature, wherein the control unit is configured to selectively switch opening and closing of the plurality of valves based on the temperature change signal.

13. The internal combustion engine of claim 8, wherein the control unit is configured to selectively switch opening and closing of the plurality of valves based on a time signal.

14. The internal combustion engine of claim 8, wherein the control unit is configured to selectively switch opening and closing of the plurality of valves based on a flow rate of the exhaust gas.

15. The internal combustion engine of claim 8 further comprising, an exhaust restriction valve configured to regulate a supply of the exhaust gas from the exhaust manifold to the exhaust recirculation system.

16. A method of actively regenerating coolers in an exhaust recirculation system, the method comprising:
arranging a plurality of coolers in a predefined configuration, the plurality of coolers configured to receive a flow of exhaust gas and a flow of coolant therethrough;
regulating at least one of the flow of exhaust gas and the coolant through each of the plurality of coolers via a plurality of valves; and
selectively switching opening and closing of the plurality of valves such that at least one of the flow of exhaust gas and the flow of coolant through at least one cooler of the plurality of coolers is regulated during an operation of the exhaust gas recirculation system, to actively regenerate the at least one cooler.

17. The method of claim 16 further comprising, arranging the coolers in parallel configuration with respect to each other.

18. The method of claim 16 further comprising, arranging the coolers in series configuration with respect to each other.

19. The method of claim 16 further comprising, selectively switching the opening and the closing of the plurality of valves based on a change in temperature of at least one of the exhaust gas and the coolant as the exhaust gas and the coolant flow through the coolers.

20. The method of claim 16 further comprising, selectively switching the opening and the closing of the plurality of valves based on time.
